(19) United States
(12) Patent Application Publication
(10) Pub. No.: US 2026/0096519 A1
(43) Pub. Date: Apr. 9, 2026

(54) METHOD OF MOVING TREE AND ROOTBALL UP AN INCLINED PATHWAY USING AIRBAGS

(71) Applicant: Environmental Design Intellectual Property Group, LLC, Tomball, TX (US)

(72) Inventors: Thomas P. Cox, Spring, TX (US); Mark A. Merit, The Woodlands, TX (US)

(21) Appl. No.: 18/907,504

(22) Filed: Oct. 5, 2024

(51) Int. Cl. A01G 23/04

(52) U.S. Cl. CPC A01G 23/043

(57) ABSTRACT

A method of moving a tree, rootball and supporting platform up an inclined surface comprising the steps of supporting the platform using a plurality of inflatable airbags, progressively, from leading edge to trailing edge, inflating the airbags to elevate the supporting platform, tree and rootball and to tilt the platform, tree and rootball forward towards the incline to be surmounted, and rolling the platform, tree and rootball forward to unload a trailing airbag and to lower the platform onto the remaining airbags. This series of steps can be repeated after a replacement leading airbag is introduced beneath the leading edge of the platform and the inclined surface to move the platform, tree and rootball further up the incline.

### BACKGROUND

### Field of the Invention

The present invention relates to the moving of a large tree with rootball for subsequent planting at a desired location. More specifically, the present invention relates to the moving of a large tree with rootball, on a supporting platform, up an inclined surface by strategic inflation and positioning of inflatable airbags.

### Background of the Related Art

Techniques have been used to move large trees with the rootball thereon. For trees with a diameter under eight inches, these trees are conventionally moved utilizing a powered spade with blades that drive downward and inward to capture the root ball, which is then lifted out of the hole and relocated to a new site.

U.S. Pat. No. 8,844,449 to the applicant herein discloses a method of moving a tree and rootball using a plurality of elongate inflatable airbags. The airbags are introduced underneath a platform that is constructed underneath the rootball of the tree, and force is applied to cause the tree, the rootball and the platform supporting the rootball and tree to roll on the airbags. As airbags are unloaded due to movement of the tree, rootball and platform, airbags are introduced forward of the platform to become loaded by forward movement of the tree, rootball and platform. This cycle is repeated until the tree, rootball and platform arrive at a prepared location whereupon the platform is removed and the tree and rootball are planted at the new location.

### BRIEF SUMMARY

One embodiment of the present invention provides a method of moving a tree, rootball and platform up an inclined pathway using airbags comprising the steps of supporting a rootball and tree on a platform proximal to an inclined surface within a pathway of desired movement of the platform, tree and rootball, then supporting the platform, tree and rootball on a plurality of parallel inflatable airbags including a leading airbag underneath a leading end of the platform and a trailing airbag underneath the trailing end of the platform. The embodiment of the method further includes the steps of progressively inflating the airbags to elevate the platform and to impart a forward tilt to the platform, rootball and tree, the forward tilt causing the tree to lean towards the inclined surface to be surmounted. “Progressively inflating,” as that phrase is used herein, means that the leading airbag supporting the leading end of the platform is inflated the least to provide a smaller diameter, the trailing airbag supporting the trailing end of the platform is inflated the most to provide a large diameter, and the intermediate airbags that are intermediate the leading airbag and the trailing airbag are each inflated in a manner so that the airbag next to the leading airbag is larger than the leading airbag and smaller than the airbag immediately trailing that airbag, and the penultimate airbag next to the trailing airbag is smaller than the trialing airbag and larger than the airbag immediately leading that airbag, and so on. The progressive inflation of the plurality of airbags in this manner elevates the center of mass of the tree, rootball and platform and imparts a forward tilt, in the direction of the inclined surface to be surmounted, of the tree, rootball and platform. The embodiment of the method of the present invention further includes the step of rolling the platform, rootball and tree downwardly and forwardly in the direction of a pathway of desired movement to surmount the inclined surface. As the platform, tree and rootball are moved in the direction of a pathway of desired movement, the trailing airbag of the plurality of airbags will be unloaded as the trailing end of the platform rolls off of the trailing airbag.

An embodiment of the method of the present invention may further include the step of introducing a replacement leading airbag underneath the leading end of the platform after the previous step of rolling the platform, rootball and tree forwardly in the direction of the pathway of desired movement results in movement of the leading airbag further from the leading end of the platform and closer to the center of the supporting platform. This replacement airbag is introduced to support the leading end of the platform.

An embodiment of the method of the present invention may further include the step of progressively inflating the airbags underneath the platform to elevate the platform and to again impart a forward tilt to the platform, rootball and tree, the forward tilt causing the tree to lean towards the inclined surface to be further surmounted, the progressive inflation of the plurality of airbags to cause the diameter of the replacement leading airbag to be the smallest and the diameter of a replacement trailing airbag, formerly the penultimate airbag, to be the largest. This step again elevates and imparts a tilt of the tree, rootball and platform towards the portion of the inclined surface to be further surmounted. The embodiment of the method of the present invention may further include the subsequent step of rolling the platform, rootball and tree downwardly and in the direction of a pathway of desired movement to further surmount the inclined surface.

The step of the embodiment of the method of the present invention of rolling the platform, rootball and tree downwardly and in the direction of a pathway of desired movement to surmount the inclined surface may include rolling the trailing end of the platform off of the trailing airbag to unload the trailing airbag and to thereby redistribute the weight of the platform, tree and rootball on a remaining subset of the plurality of airbags. This redistribution of the weight of the platform, tree and rootball on the remaining subset of the plurality of airbags results in rotation of the platform, tree and rootball about its center of mass and back in the direction opposite to the tilting of the platform, tree and rootball resulting from the progressive inflation of the plurality of airbags.

The elevation of the platform, tree and rootball by strategic and progressive inflation of the plurality of airbags increases the amount of potential energy in the platform, tree and rootball to provide the energy required in rolling the platform, tree and rootball forward and off of the trailing airbag. The center of mass of the platform, tree and rootball will be higher, prior to the step of rolling the platform, tree and rootball downwardly and in the direction of the pathway of desired movement than it will be after the rolling step. Concurrently with the lowering of the center of mass of the platform, tree and rootball, the rolling of the trailing end of the platform to unload and release the trailing airbag from underneath the platform causes the platform, tree and rootball to rotate away from the inclined surface to be surmounted as the platform, tree and rootball descend.

It will be understood that many factors will influence the implementation of an embodiment of the method of the present invention including, but not limited to, the dimensions of the platform, tree and rootball, the mass of the platform, tree and rootball, the slope of the inclined surface to be surmounted, the extent to which the platform, tree and rootball are elevated and tilted, the elasticity of the airbags, the number of the airbags and the spacing of the airbags underneath the platform.

### BRIEF DESCRIPTION OF THE SEVERAL VIEWS OF THE DRAWINGS

FIG. 1 is an illustration showing a rootball, tree and supporting platform supported on an incline by a plurality of airbags after the airbags have been strategically and progressively inflated to elevate and tilt the rootball, tree and supporting platform towards the incline to be surmounted.

FIG. 2 is the illustration of FIG. 1 showing the rootball, tree and supporting platform after the platform supporting the rootball and tree is allowed to move forward and downwardly, and to roll the platform off of the trailing airbag.

FIG. 3 is the illustration of FIG. 2 showing the rootball, tree and supporting platform after the platform is re-elevated and re-tilted by strategic and progressive inflation of the airbags to re-elevate and tilt the platform, tree and rootball.

FIG. 4 is the illustration of FIG. 3 showing the rootball, tree and supporting platform after the platform supporting the rootball and tree is again allowed to move forward and downwardly, and to roll the platform off of the trailing airbag.

### DETAILED DESCRIPTION OF AN EMBODIMENT OF THE METHOD

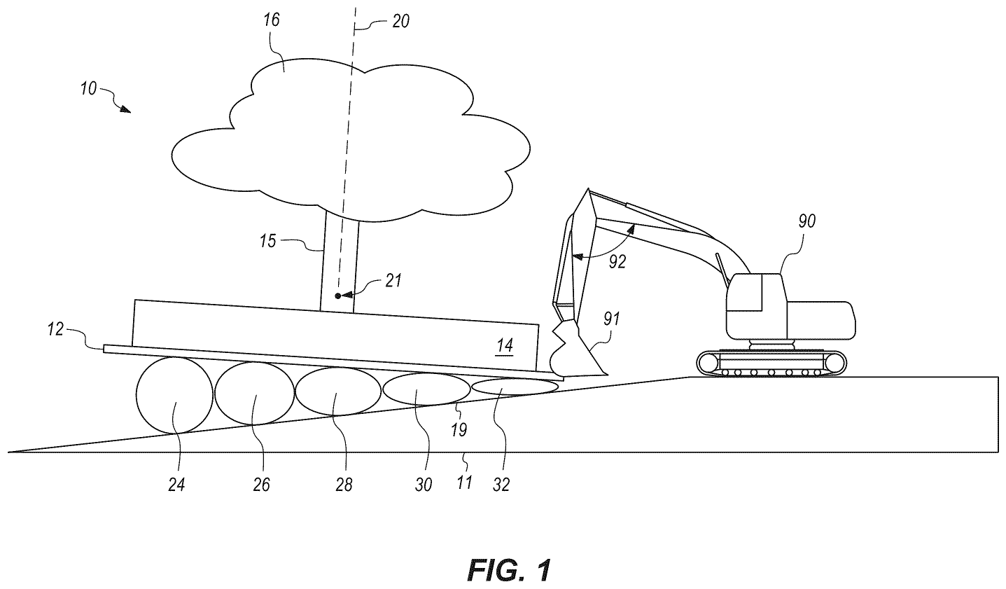

FIG. 1 is an illustration showing a rootball 14, tree 16 and supporting platform 12 supported on an inclined surface 19 by a plurality of airbags 24, 26, 28, 30 and 32 after the airbags 24, 26, 28, 30 and 32 have been strategically and progressively inflated to elevate and tilt the rootball 14, tree 16 and supporting platform 12 towards the incline 19 to be surmounted. The axis 20 of the tree 16 is centered within the trunk 15 of the tree 16. The axis 20 in FIG. 1 is shown tilted forward in the direction of desired movement up the inclined surface 19. The tilt of the axis 20 and the elevated position of the rootball 14, tree 16 and supporting platform 12 are the result of strategic positioning and progressive inflation of the plurality of airbags 24, 26, 28, 30 and 32. The center of mass 21 is positioned along, or in close proximity to, the axis 20. A vector drawn true vertical and downwardly from the center of mass 21 is the sum of two vectors: one directed along the axis 20 of the trunk 15 of the tree 16 and another perpendicular to the axis 20 and directed laterally along the platform 12 and in the direction of the incline 19 to be surmounted. It is the latter vector that indicates the component of the mass of the rootball 14, tree 16 and supporting platform 12 that urges the rootball 14, tree 16 and supporting platform 12 to roll downwardly and forwardly along the plurality of airbags 24, 26, 28, 30 and 32.

Also shown in FIG. 1 are a track hoe 90 having an articulating boom 93 and a bucket 91 connected to the boom 93. Optionally, a track hoe 90 or other piece of heavy equipment such as, for example, but not limited to, a bulldozer, a tractor or other machinery can be used to stabilize the platform 12 or to assist in moving the platform 12, tree 16 and rootball 14 in the desired direction. The bucket 91 of the boom 93 of the track hoe 90 shown in FIG. 1 is shown connected to the leading end 12A of the platform 12.

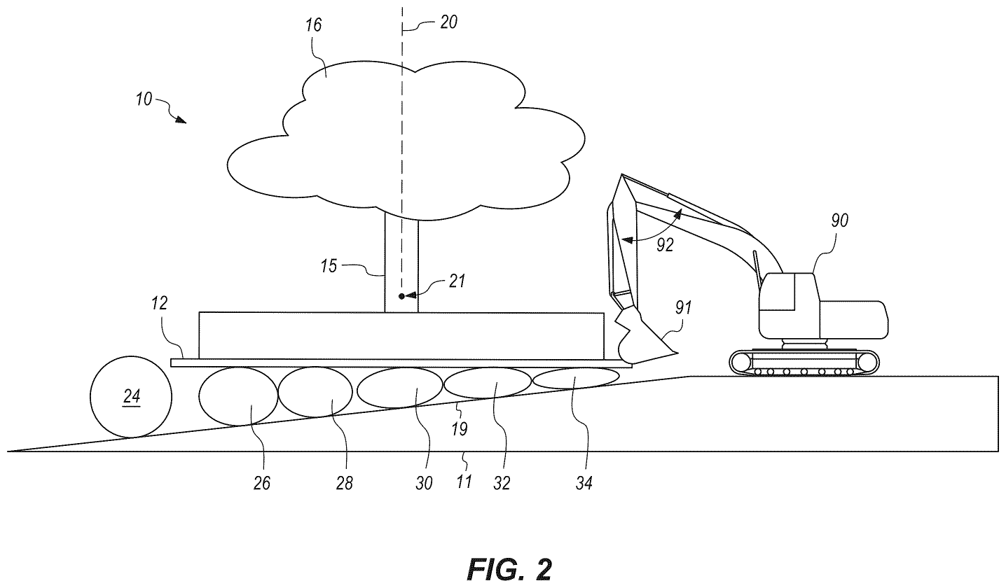

FIG. 2 is the illustration of FIG. 1 showing the rootball 14, tree 16 and supporting platform 12 after the platform 12 supporting the rootball 14 and tree 16 is allowed to move forward and downwardly, and to roll the platform 12 off of the trailing airbag 24. This movement of the platform 12 from the position shown in FIG. 1 to the position shown in FIG. 2 unloads the trailing airbag 24 and redistributes the mass of the platform 12, rootball 14 and tree 16 among the remaining subset of the plurality of airbags, those airbags in that remaining subset being airbags 26, 28, 30 and 32. FIG. 2 also shows a replacement leading airbag 34 that has been introduced intermediate the leading end 12A of the platform 12 and the inclined surface 19. The trailing airbag 24 that has been unloaded by the movement of the platform 12 from the position shown in FIG. 1 to the position shown in FIG. 2 may be deflated and then introduced into the position in which the replacement airbag 34 is shown, or the replacement airbag 34 may be another airbag not used to support the platform 12 in FIG. 1. The ovality of the remaining subset of airbags 26, 28, 30 and 32 may be exaggerated by the extra mass that has been redistributed among them by movement of the platform 12 off of the trailing airbag 24. The angle 92 of the articulating boom 93 shown in FIG. 1 has been reduced in FIG. 2 to reflect the manner in which a track hoe 90 may optionally be used to stabilize and to assist in moving of the platform 12 and the tree 16 and rootball 14 supported thereon.

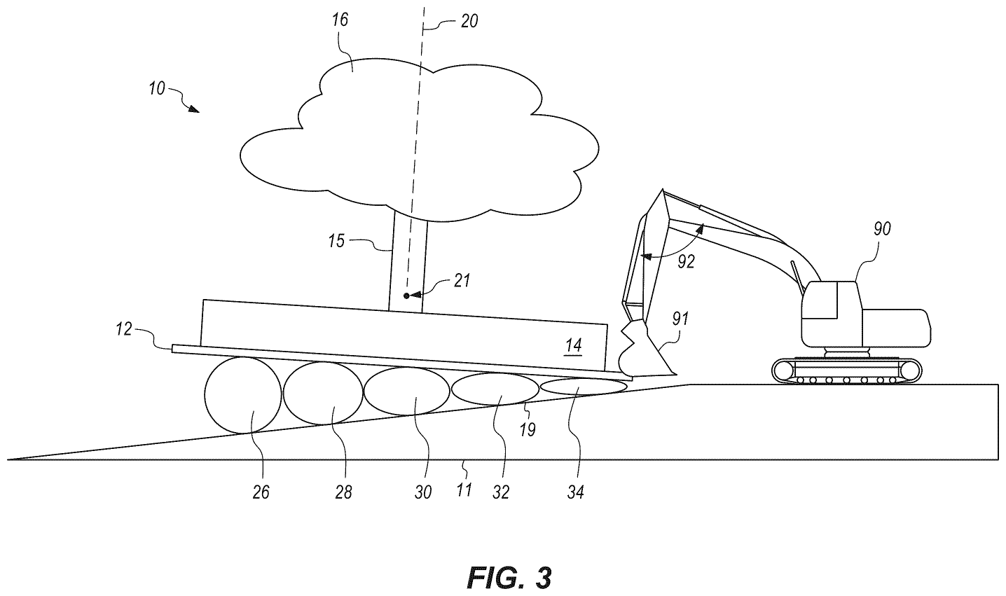

FIG. 3 is the illustration of FIG. 2 showing the rootball 14, tree 16 and supporting platform 12 after the platform 12 is re-elevated and re-tilted by strategic and progressive inflation of the airbags 26, 28, 30, 32 and 34 to re-elevate and to tilt the platform 12, tree 16 and rootball 14 in the direction of the intended pathway of movement and in the direction of the incline 19 to be surmounted.

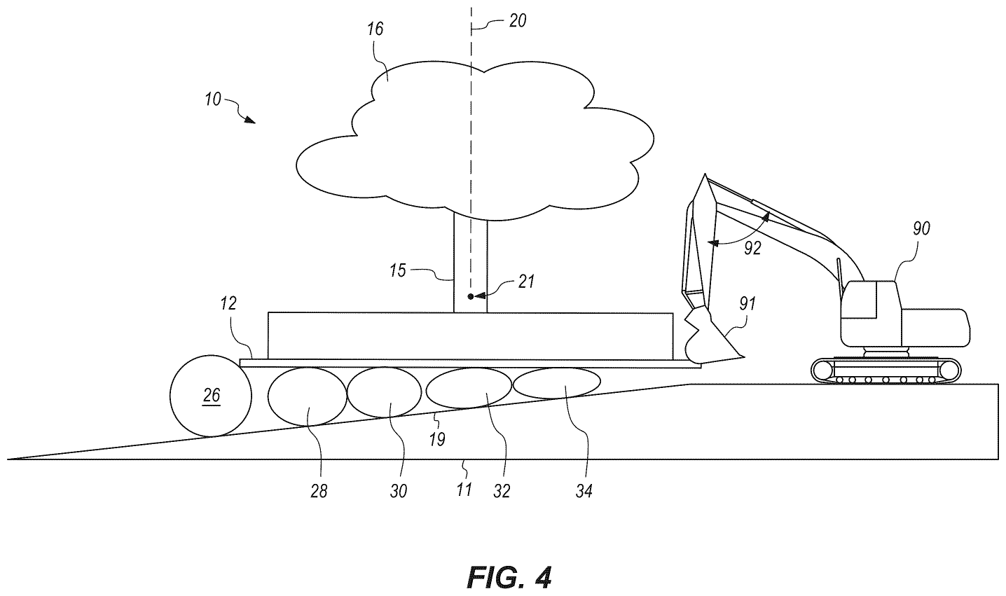

FIG. 4 is the illustration of FIG. 3 showing the rootball 14, tree 16 and supporting platform 12 after the platform 12 supporting the rootball 14 and tree 16 is again allowed to move forward and downwardly from the position shown in FIG. 3, and to roll the platform 12 off of the replacement trailing airbag 26. As a result, the mass of the platform 12, tree 16 and rootball 14 is redistributed among the remaining subset of airbags 28, 30, 32 and 34. As shown in FIG. 4, the platform 12 is sufficiently aligned with the top 19A of the inclined surface 19 to be surmounted and can, from the position shown in FIG. 4, be elevated by strategic inflation of the remaining subset of airbags and moved forward.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising the steps of:
supporting a rootball and tree on a platform proximal to an inclined surface within a pathway of desired movement of the platform, tree and rootball;
supporting the platform, tree and rootball on a plurality of parallel inflatable airbags including a leading airbag underneath a leading end of the platform and a trailing airbag underneath the trailing end of the platform;
progressively inflating the airbags to elevate the platform and to impart a forward tilt to the platform, rootball and tree, the forward tilt causing the tree to lean towards the inclined surface to be surmounted, the progressive inflation of the plurality of airbags causing the diameter of the leading airbag to be the smallest and the diameter of the trailing airbag to be the largest; and
rolling the platform, rootball and tree downwardly and in the direction of a pathway of desired movement to surmount the inclined surface.

2. The method of claim 1, further comprising the step of:
introducing a replacement leading airbag underneath the leading end of the platform;
progressively inflating the airbags to elevate the platform and to again impart a forward tilt to the platform, rootball and tree, the forward tilt causing the tree to lean towards the inclined surface to be further surmounted, the progressive inflation of the plurality of airbags causing the diameter of the replacement leading airbag to be the smallest and the diameter of a replacement trailing airbag to be the largest; and
rolling the platform, rootball and tree downwardly and in the direction of a pathway of desired movement to further surmount the inclined surface.

3. The method of claim 1, wherein the step of rolling the platform, rootball and tree downwardly and in the direction of a pathway of desired movement to surmount the inclined surface includes rolling the trailing end of the platform off of the trailing airbag to unload the trailing airbag and to redistribute the weight of the platform, tree and rootball on a remaining subset of the plurality of airbags.

4. The method of claim 3, wherein the unloading of the trailing airbag causes the weight of the platform, tree and rootball to be redistributed among a remaining subset of the plurality of airbags, thereby reducing the tilt of the tree.
